(19) United States
(12) Patent Application Publication
(10) Pub. No.: US 2025/0096654 A1
(43) Pub. Date: Mar. 20, 2025

(54) DEVICE FOR TESTING THE ROTATION SPEED OF ROTOR ASSEMBLY

(71) Applicant: ZHEJIANG INNUOVO MAGNETICS CO., LTD., DONGYANG, Zhejiang Province (CN)

(72) Inventors: PENGPENG FU, DONGYANG, ZHEJIANG PROVINCE (CN); TINGRU LV, DONGYANG, ZHEJIANG PROVINCE (CN); JIANFEI HE, DONGYANG, ZHEJIANG PROVINCE (CN); JIANFENG HE, DONGYANG, ZHEJIANG PROVINCE (CN); QINGHUA ZHU, DONGYANG, ZHEJIANG PROVINCE (CN); XIAOMING HU, DONGYANG, ZHEJIANG PROVINCE (CN)

(21) Appl. No.: 18/711,586

(22) PCT Filed: Aug. 4, 2022
(86) PCT No.: PCT/CN2022/110154

§ 371 Date: Dec. 6, 2024

(30) Foreign Application Priority Data
Dec. 22, 2021 (CN) 202111580190.5

(51) Int. Cl. H02K 11/22; H02K 7/08

(52) U.S. Cl. CPC H02K 11/22; H02K 7/08

(57) ABSTRACT

The present invention relates to a device for testing the rotation speed of a rotor assembly, and belongs to the technical field of rotor assemblies. The device comprises a base on which a workpiece support station for horizontal placement of a rotor assembly is provided. A speed measurement element for measuring the rotation speed of the rotor shaft is indirectly or directly fixed on the base. A driving component for driving the rotor shaft to rotate is provided on one horizontal side of the workpiece support station. The driving component comprises an air inlet seat and an impeller. A rotating groove for allowing to the impeller to rotate therein is formed at the end of the air inlet seat facing the workpiece support station. An opening for allowing the impeller to enter therein is formed at the end of the rotating groove, and the outer circumferential side of the rotating groove is communicated with air inlet ages communicated with an external air source. The present invention can stably convert the input air source into the rotation speed and stably output the rotation speed, can satisfy the testing requirements for high rotation speed, and can ensure the stability of testing, and so on.

### TECHNICAL FIELD OF THE INVENTION

The present invention relates to a device for testing the rotation speed of a rotor assembly, and belongs to the technical field of rotor assemblies.

### BACKGROUND OF THE INVENTION

The rotor assembly of the motor generally includes a rotor core fixed on a rotor shaft. The rotor core includes a magnet with a hole, and the rotor shaft is received through this hole. Since most magnets are brittle, the magnets will break if they are subjected to excessive stress. Thus, it is necessary to test the rotor assembly at a high rotation speed under specific curve requirements. During testing, the rotation speed should exceed 200,000 rpm and can run reliably for a period of time, thereby determining the strength and reliability of the rotor assembly. At present, a way of combining a magnetic component, a circuit board fixation magnetic component and a shell together is usually adopted. Specifically, the shell is nested on the target object, so that the target object drives the magnetic component to rotate; the magnetic component provides a trigger magnetic field for the circuit board; and, the circuit board outputs square wave signals according to the trigger magnetic field and sends the square wave signals to the controller, so that the controller detects the rotation direction and speed of the target object through the square wave signals. The magnet of the magnetic component is fixed in the plastic shell, and the plastic shell may be cracked at a high rotation speed, so that the testing requirements for high rotation speed cannot be satisfied. Moreover, the detection device is fixed on the rotor system, so it is difficult to ensure the stability of testing due to uneven mass distribution.

### SUMMARY OF THE INVENTION

### Technical Problem

The object of the present invention is to provide a device for testing the rotation speed of a rotor assembly, which solves the problems in the prior art that the testing requirements for high rotation speed cannot be satisfied and it is difficult to ensure the stability of testing.

### Problem's Solution

### Technical Solution

The technical object of the present invention is mainly solved by the following technical solutions. A device for testing the rotation speed of a rotor assembly is provided, including a base, wherein a workpiece support station for horizontal placement of a rotor assembly is provided on the base; the workpiece support station and a rotor shaft in the rotor assembly form a rotary support; a speed measurement element for measuring the rotation speed of the rotor shaft is indirectly or directly fixed on the base; a driving component for driving the rotor shaft to rotate is provided on one horizontal side of the workpiece support station; the driving component includes an air inlet seat and an impeller that is sleeved on the end of the rotor shaft and can rotate synchronously with the rotor shaft; a rotating groove for allowing the impeller to rotate therein is formed at the end of the air inlet seat facing the workpiece support station; an opening for allowing the impeller to enter therein is formed at the end of the rotating groove; and, the outer circumferential side of the rotating groove is communicated with air inlet passages communicated with an external air source.

When in use of the device of the present invention, firstly, the impeller is sleeved on the rotor shaft to form the rotor assembly; then, the rotor assembly is horizontally placed on the workpiece support station, and the impeller enters the rotating groove through the opening of the rotating groove; then, the external air source is controlled to transport air into the air inlet passages, and the incoming air is blown to the impeller in the circumferential direction of the rotating groove through the air inlet passages so as to allow the impeller to rotate at a high speed, so that the rotor shaft can be driven to rotate at a high speed; subsequently, the rotation speed of the rotor assembly is tested by measuring the rotation speed value of the rotor shaft by the speed measurement element. When the air source is stable, the present invention can stably convert the input air source into the rotation speed and stably output the rotation speed, can satisfy the testing requirements for high rotation speed, and can ensure the stability of testing.

Preferably, the air inlet passages horizontally pass through the rotating groove and run through two horizontal ends of the air inlet seat; one end of each of the air inlet passages is communicated with the external air source, while the other end thereof is communicated with an external space; and, the outer ends of vanes of the impeller are located in the air inlet passages.

By arranging the air inlet passages to horizontally pass through the rotating groove and run through two horizontal ends of the air inlet seat, one end of each of the air inlet passages is communicated with the external air source, while the other end thereof is communicated with an external space. The outer ends of vanes of the impeller are located in the air inlet passages, so that the air entering through the air inlet passages can be directly blown to the outer ends of the vanes of the impeller so as to rotate the impeller, thereby realizing low energy consumption. Moreover, since the both ends of the air inlet passages are open, air convection can occur, so that the air can flow quickly to blow the impeller to rotate at a high speed. Furthermore, the energy conversion efficiency is high, and the testing cost can be effectively reduced.

Preferably, there are two air inlet passages, the two air inlet passages are arranged at intervals in the height direction of the air inlet seat, and two ends of the two air inlet passages on the same side are communicated with the external air source and the external space, respectively.

By providing two air inlet passages, arranging the two air inlet passages at intervals in the height direction of the air inlet seat and communicating two ends of the two air inlet passages on the same side with the external air source and the external space respectively, the air entering through the two air inlet passages can be blown to the outer ends of the vanes of the impeller in opposite directions, so that the impeller can have a higher rotation speed to further satisfy the testing requirements for high rotation speed.

Preferably, the driving component further includes a baffle that is sleeved on the rotor shaft and located on the inner side of the impeller; and, when the impeller is located in the rotating groove, the opening of the rotating groove is closed by the baffle.

By further providing on the driving component a battle that is sleeved on the rotor shaft and the located on the inner side of the impeller, when the impeller is located in the rotating groove, the opening of the rotating groove is closed by the baffle, so that the air can be prevented from blowing to one side of the workpiece placement station through the baffle during testing, thereby avoiding the stable placement of the rotor assembly on the workpiece placement station and ensuring the stability of testing. In addition, the baffle can limit the impeller, thereby avoiding movement towards one side of the workpiece placement station along the rotor shaft during high-speed rotation and preventing the impeller from damage by collision.

Preferably, the sectional shape of the rotating groove is circular, and the diameter of the rotating groove is greater than the outer diameter of the impeller.

By setting the sectional shape of the rotating groove to be circular and the diameter of the rotating groove to be greater than the outer diameter of the impeller, the impeller can rotate at a high speed in the rotating groove, and the circular inner wall of the rotating groove enables part of the air to flow in the circumferential direction of the impeller, so that the air can better blow the impeller to rotate.

Preferably, the workpiece support station includes two bearings which are sleeved at intervals on the rotor shaft and can rotate synchronously with the rotor shaft; the two bearings are located on the same side of the impeller; the workpiece support station further includes two support seats indirectly or directly fixed on the base; the two support seats are arranged at intervals in the left-right direction; and, positioning round holes that run through the left and right ends of the support seats and adapt to the bearings are formed in the support seats.

By providing in the workpiece support station two bearings which are sleeved at intervals on the rotor shaft and can rotate synchronously with the rotor shaft, locating the two bearings on the same side of the impeller, allowing the workpiece support station to further include two support seats indirectly or directly fixed on the base, arranging the two support seats at intervals in the left-right direction, and forming in the support seats positioning round holes that run through the left and right ends of the support seats and adapt to the bearings, when the rotor assembly is horizontally placed on the two support seats in the axial direction of the positioning round holes, the rotary support to the rotor shaft can be realized through the fitting between the outer circles of the two bearings on the rotor shaft and the inner walls of the positioning round holes, so that the rotor shaft can rotate during testing.

Preferably, clearance slots extending upward vertically are communicatively formed on the tops of the positioning round holes; the clearance slots run through the left and right ends of the support seats and have openings formed on their tops; threaded holes horizontally running through the clearance slots are formed in the support seats; and, adjustment screws are in threaded fit in the threaded holes.

By communicatively forming clearance slots extending upward vertically on the tops of the positioning round holes, allowing the clearance slots to run through the left and right ends of the support seats and have openings formed on their tops, and forming threaded holes horizontally running through the clearance slots in the support seats, the operator can adjust the spacing between the clearance slots by rotating the adjustment screws, so as to adjust the fastening of the bearings and the relative position of the rotor assembly before testing, so that the occurrence of jamming of the rotor assembly caused by accumulated errors can be reduced, and the rotor assembly can move at a relative low degree of freedom. Thus, the friction of the rotor at a high speed is improved, the relative service life of the bearings is effectively improved, and the rotor assembly can satisfy the requirements for high rotation speed under a lower driving force.

Preferably, the air inlet seat is detachably fixed on the base, the air inlet seat is located on the outer side of one of the support seats, and the baffle is restricted between the air inlet seat and the support seat.

By detachably the air inlet seat on the base, locating the air inlet seat on the outer side of one of the support seats and restricting the baffle between the air inlet seat and the support seat, a group of rotor assemblies can be take out from the support seat after testing by detaching the air inlet set, and a next group of rotor assemblies to be tested is mounted, so that it is convenient for continuous testing of rotor assemblies.

Preferably, the device further includes a shell fixed on the base; the workpiece support station is arranged in the shell; the shell is located on the left side of the air inlet seat; an opening is formed on the side of the shell facing the air inlet seat; the support seat on the right side is located at the opening; and, the opening is closed by the baffle.

By providing a shell located on the base, arranging the workpiece support station in the shell, locating the shell on the left side of the air inlet seat, forming an opening on the side of the shell facing the air inlet seat, locating the support seat on the right side at the opening and closing the opening by the baffle, the rotor assembly placed on the workpiece support station can be located in a relatively closed environment by using the shell, so that the rotor assembly is tested in simulated environments with different temperatures. In addition, the operator can place the rotor assembly on the support seat or take out the rotor assembly through the opening, and cooperate with the disassembly of the air inlet seat, thereby placing or taking out the rotor assembly.

Preferably, two operating passages horizontally extending to the two support seats are formed on one side of the shell; and, the extension ends of the operating passages are communicated with the threaded holes and correspond to the heads of the adjustment screws, while the other ends of the operating passages are formed with openings.

By forming two operating passages horizontally extending to the two support seats on one side of the shell, allowing the extension ends of the operating passages to be communicated with the threaded holes and correspond to the heads of the adjustment screws and forming openings at the other ends of the operating passages, the operator can extend a tool through the operating passages to rotate the adjustment screws after the rotor assembly is placed, thereby adjusting the fastening of the bearings.

Preferably, the speed measurement element is a laser speed measurement probe, the speed measurement element is fixed on the top of the shell through a fixation plate, and a light passage hole for allowing the laser of the speed measurement element to pass therethrough is formed on the top of the shell.

By setting the speed measurement element as a laser speed measurement probe, fixing the speed measurement element on the top of the shell through a fixation plate and forming a light passage hole for allowing the laser of the speed measurement element to pass therethrough on the top of the shell, the laser emitted by the speed measurement element during operation can be sent out to the rotor shaft on the workpiece support station through the light passage hole, thereby realizing the measurement of the rotation speed of the rotor shaft.

### Invention's Beneficial Results

### Beneficial Results

Thus, when the air source is stable, the present invention can stably convert the input air source into the rotation speed and stably output the rotation speed, can satisfy the testing requirements for high rotation speed, and can ensure the stability of testing, and so on.

### BRIEF DESCRIPTION OF THE DRAWINGS

### Description of the Drawings

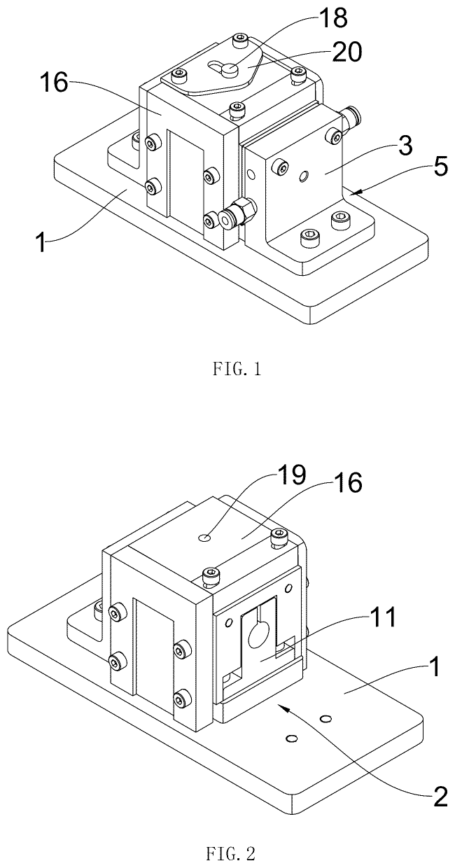

FIG. 1 is a stereoscopic structure diagram of the present invention in one direction;

FIG. 2 is a structure diagram during mounting a rotor assembly in the present invention;

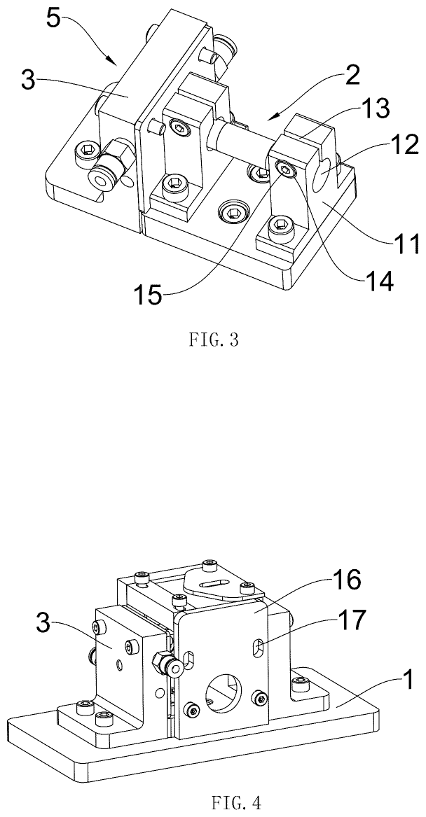

FIG. 3 is a stereoscopic structure diagram of the workpiece support station and the driving component in the present invention;

FIG. 4 is a stereoscopic structure diagram of the present invention in another direction;

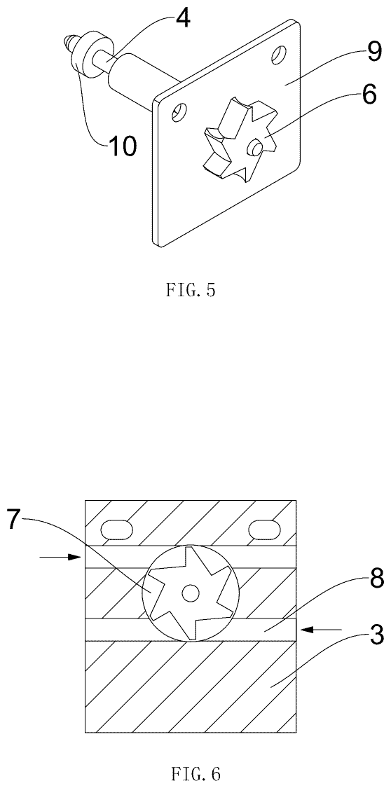

FIG. 5 is stereoscopic structure diagram of the rotor assembly in the present invention; and

FIG. 6 is a sectional view of the air inlet seat the present invention.

Reference numerals in the drawings are given below: 1: base; 2: workpiece support station; 3: air inlet seat; 4: rotor shaft; 5: driving component; 6: impeller; 7: rotating groove; 8: air inlet passage; 9: baffle; 10: bearing; 11: support seat; 12: positioning round hole; 13: clearance slot; 14: threaded hole; 15: adjustment screw; 16: shell; 17: operating passage; 18: speed measurement element; 19: light passage hole; and, 20: fixation plate.

### DETAILED DESCRIPTION OF THE INVENTION

### The Best Way(s) to Implement of Invention

The technical solutions of the present invention will be further described below by specific embodiments with reference to the accompanying drawings.

As shown in FIGS. 1, 2, 3 and 5, the present invention provides a device for testing the rotation speed of a rotor assembly, including a base 1 and a shell 16 fixed on the base 1. A speed measurement element 18 for measuring the rotation seed of a rotor shaft 4 is indirectly fixed on the base 1. The speed measurement element 18 is a laser speed measurement probe, and the speed measurement element 18 is fixed on the top of the shell 16 through a fixation plate 20. A light passage hole 19 for allowing the laser emitted by the speed measurement element 18 to pass therethrough is formed on the top of the shell 16. A workpiece support station 2 for horizontal placement of a rotor assembly is provided on the base 1. The workpiece support station 2 is arranged in the shell 16, and the workpiece support station 2 and the rotor shaft 4 in the rotor assembly form a rotary support. The workpiece support station 2 includes two bearings 10 which are sleeved on the rotor shaft 4 at intervals and can rotate synchronously with the rotor shaft 4. The two bearings 10 are located on the same side of the impeller 6. The workpiece support station 2 further includes two support seats 11 indirectly or directly fixed on the base 1. The two support seats 11 are arranged at intervals in the left-right direction, and the support seats 11 are bearing seats. Positioning round holes 12 that run through the left and right ends of the support seats 11 and adapt to the bearings 10 are formed in the support seats 11. Clearance slots 13 extending upward vertically are communicatively formed on the tops of the positioning round holes 12. The clearance slots 13 are rectangular, and the clearance slots 13 run through the left and right ends of the support seats 11 and have openings formed on their tops. Threaded holes 14 horizontally running through the clearance slots 13 are formed in the support seats 11, and adjustment screws 15 are in threaded fit in the threaded holes 14. The adjustment screws 15 are hexagon socket screws.

As shown in FIGS. 2 and 4, the shell 16 is located on the left side of the air inlet seat 3, transparent observation windows are formed on the front side and top of the shell 16. An opening is formed on the side of the shell 16 facing the air inlet seat 3, the support seat 11 on the right side is located at the opening, and the opening is closed by the baffle 9. Two operating passages 17 horizontally extending to the two support seats 11 are formed on one side of the shell 16. The extension ends of the operating passages 17 are communicated with the threaded holes 14 and correspond to the heads of the adjustment screws 15, while the other ends of the operating passages 17 are formed with openings.

As shown in FIGS. 3, 5 and 6, a driving component 5 for driving the rotor shaft 4 to rotate is provided on one horizontal side of the workpiece support station 2. The driving component 5 includes an air inlet seat 3 and an impeller 6 that is sleeved on the end of the rotor shaft 4 and can rotate synchronously with the rotor shaft 4. The impeller 6 may also be a fan. The air inlet seat 3 is detachably fixed on the base 1. The air inlet seat 3 is connected and fixed to the base 1 through a hexagon socket screw. The air inlet seat 3 is located on the outer side of one of the support seats 11, and a rotating groove 7 for allowing the impeller 6 to rotate therein is formed at the end of the air inlet seat 3 facing the workpiece support station 2. The section of the rotating groove 7 is circular, and the diameter of the rotating groove 7 is greater than the outer diameter of the impeller 6. An opening for allowing the impeller to enter therein is formed at the end of the rotating groove 7. The driving component 5 further includes a baffle 9 that is sleeved on the rotor shaft 4 and located on the inner side of the impeller 6. When the impeller 6 is located in the rotating groove 7, the opening of the rotating groove 7 is closed by the baffle 9. The baffle 9 is restricted between the air inlet seat 3 and the support seat 11.

As shown in FIG. 6, the outer circumferential side of the rotating groove 7 is communicated with air inlet passages 8 communicated with an external air source. The sections of the air inlet passages 8 are circular. The air inlet passages 8 horizontally pass through the rotating groove 7 and run through two horizontal ends of the air inlet seat 3. One end of each of the air inlet passages 8 is communicated with the external air source, an air nozzle is mounted at the end of the air inlet passage 8 communicated with the external air source, and the external air source is an air compressor. The other end of each of the air inlet passages 8 is communicated with an external space. The outer ends of vanes of the impeller 6 are located in the air inlet passages 8. There are two air inlet passages 8, the two air inlet passages 8 are arranged at intervals in the height direction of the air inlet seat 3, and two ends of the two air inlet passages 8 on the same side are communicated with the external air source and the external space, respectively.

In this embodiment, during specific implementations, firstly, the impeller 6, the baffle 9 and the two bearings 10 are sleeved on the rotor shaft 4 to form the rotor assembly; then, the air inlet seat 3 is taken down from the base 1, one sides of the bearings 10 of the rotor assembly are mounted into the positioning round holes 12 from one side of the support seat 11 on the right side, and the two bearings 10 are located in the corresponding positioning round holes 12; then, the air inlet seat 11 is fixedly mounted at the specified position on the base 1, the impeller 6 enters the rotating groove 7 through the opening of the rotating groove 1, and the baffle 9 is located between the support seat 11 on the right side and the air inlet seat 3; subsequently, the external air source is controlled to transport air into two ends of the two air inlet passages on different sides, and the incoming air is blown to the outer ends of the vanes of the impeller 6 in opposite directions through the air inlet passages 8 so as to drive the impeller to rotate at a high speed, so that the rotor shaft 4 is driven to rotate at a high speed. At this time, the rotation speed of the rotor assembly is tested by measuring the rotation speed value of the rotor shaft 4 by the speed measurement element 18.

When the air source is stable, the present invention can stably convert the input air source into the rotation speed and stably output the rotation speed, can satisfy the testing requirements for high rotation speed, and can ensure the stability of testing, and so on.

1. A device for testing the rotation speed of a rotor assembly, comprising a base (1), wherein a workpiece support station (2) for horizontal placement of a rotor assembly is provided on the base (1); the workpiece support station (2) and a rotor shaft (4) in the rotor assembly form a rotary support; a speed measurement element (18) for measuring rotation speed of the rotor shaft (4) is indirectly or directly fixed on the base (1); a driving component (5) for driving the rotor shaft (4) to rotate is provided on one horizontal side of the workpiece support station (2); the driving component (5) comprises an air inlet seat (3) and an impeller (6) that is sleeved on the end of the rotor shaft (4) and can rotate synchronously with the rotor shaft (4); a rotating groove (7) for allowing the impeller (6) to rotate therein is formed at the end of the air inlet seat (3) facing the workpiece support station (2); an opening for allowing the impeller (6) to enter therein is formed at the end of the rotating groove (7); and, the outer circumferential side of the rotating groove (7) is communicated with air inlet passages (8) communicated with an external air source.

2. The device for testing the rotation speed of a rotor assembly according to claim 1, wherein the air inlet passages (8) horizontally pass through the rotating groove (7) and run through two horizontal ends of the air inlet seat (3); one end of each of the air inlet passages (8) is communicated with the external air source, while the other end thereof is communicated with an external space; and, the outer ends of vanes of the impeller (6) are located in the air inlet passages (8).

3. The device for testing the rotation speed of a rotor assembly according to claim 2, wherein there are two air inlet passages (8), the two air inlet passages (8) are arranged at intervals in the height direction of the air inlet seat (3), and two ends of the two air inlet passages (8) on the same side are communicated with the external air source and the external space, respectively.

4. The device for testing the rotation speed of a rotor assembly according to claim 1, wherein the driving component (5) further comprises a baffle (9) that is sleeved on the rotor shaft (4) and located on the inner side of the impeller (6); and, when the impeller (6) is located in the rotating groove (7), the opening of the rotating groove (7) is closed by the baffle (9).

5. The device for testing the rotation speed of a rotor assembly according to claim 4, wherein the workpiece support station (2) comprises two bearings (10) which are sleeved at intervals on the rotor shaft (4) and can rotate synchronously with the rotor shaft (4); the two bearings (10) are located on the same side of the impeller (6); the workpiece support station (2) further comprises two support seats (11) indirectly or directly fixed on the base (1); the two support seats (11) are arranged at intervals in the left-right direction; and, positioning round holes (12) that run through the left and right ends of the support seats (11) and adapt to the bearings (10) are formed in the support seats (11).

6. The device for testing the rotation speed of a rotor assembly according to claim 5, wherein clearance slots (13) extending upward vertically are communicatively formed on the tops of the positioning round holes (12); the clearance slots (13) run through the left and right ends of the support seats (11) and have openings formed on their tops; threaded holes (14) horizontally running through the clearance slots (13) are formed in the support seats (11); and, adjustment screws (15) are in threaded fit in the threaded holes (14).

7. The device for testing the rotation speed of a rotor assembly according to claim 5, wherein the air inlet seat (3) is detachably fixed on the base (1), the air inlet seat (3) is located on the outer side of one of the support seats (11), and the baffle (9) is restricted between the air inlet seat (3) and the support seat (11).

8. The device for testing the rotation speed of a rotor assembly according to claim 5, wherein the device further comprises a shell (16) fixed on the base (1); the workpiece support station (2) is arranged in the shell (16); the shell (16) is located on the left side of the air inlet seat (3); an opening is formed on the side of the shell (16) facing the air inlet seat (3); the support seat (11) on the right side is located at the opening; and, the opening is closed by the baffle (9).

9. The device for testing the rotation speed of a rotor assembly according to claim 8, wherein two operating passages (17) horizontally extending to the two support seats (11) are formed on one side of the shell (16); and, the extension ends of the operating passages (17) are communicated with the threaded holes (14) and correspond to the heads of the adjustment screws (15), while the other ends of the operating passages (17) are formed with openings.

10. The device for testing the rotation speed of a rotor assembly according to claim 8, wherein the speed measurement element (18) is a laser speed measurement probe, the speed measurement element (18) is fixed on the top of the shell (16) through a fixation plate, and a light passage hole (19) for allowing the laser of the speed measurement element (18) to pass therethrough is formed on the top of the shell (16).

11. The device for testing the rotation speed of a rotor assembly according to claim 2, wherein the driving component (5) further comprises a baffle (9) that is sleeved on the rotor shaft (4) and located on the inner side of the impeller (6); and, when the impeller (6) is located in the rotating groove (7), the opening of the rotating groove (7) is closed by the baffle (9).

12. The device for testing the rotation speed of a rotor assembly according to claim 3, wherein the driving component (5) further comprises a baffle (9) that is sleeved on the rotor shaft (4) and located on the inner side of the impeller (6); and, when the impeller (6) is located in the rotating groove (7), the opening of the rotating groove (7) is closed by the baffle (9).
